(19) United States
(12) Patent Application Publication
(10) Pub. No.: US 2002/0001213 A1
(43) Pub. Date: Jan. 3, 2002

(54) INTEGRATED CIRCUIT (IC) SWITCHING POWER CONVERTER

(75) Inventors: RODERICK T. HINMAN, NATICK, MA (US); PAUL VELDMAN, OSS (NL)

Correspondence Address: JACK E HAKEN, US PHILIPS CORPORATION, CORPORATE PATENT COUNSEL, 580 WHITE PLAINS ROAD, TARRYTOWN, NY, 10591

(73) Assignee: PHILIPS ELECTRONICS NORTH AMERICA CORPORATION

(21) Appl. No.: 09/316,557

(22) Filed: May 24, 1999

(51) Int. Cl. H02M 1/00

(52) U.S. Cl. 363/147

(57) ABSTRACT

An integrated circuit (IC) switching power converter includes a main power supply for providing a main voltage output and an auxiliary power supply for providing an auxiliary voltage output lower than the main voltage output. All of the integrated components of the main power supply and the auxiliary power supply are formed in a single IC die which is mounted in a single IC package. For improved economy and/or efficiency, the main power supply and the auxiliary power supply can share external electrical connection pins, and the two power supplies may also share circuitry.

### BACKGROUND OF THE INVENTION

The invention is in the field of integrated circuit (IC) switching power converters, and relates more particularly to switching power converters of the type having a main power supply and an auxiliary power supply.

Switching power converters, used in switched-mode power supplies, and the circuits used therein, are generally well known in the art. They are typically used to obtain good regulation as well as efficient and economical filtering, since smaller-value filtering components can be used because of the typically high switching frequency used.

In addition to the main power supply in the switching power converter, an auxiliary (typically lower-voltage) power supply is often required to power the control circuitry of the converter, and possibly also other circuits of the switched-mode power supply. Ideally, such an auxiliary supply should create a low voltage with a relatively low power requirement, and should operate efficiently and use low-cost componentry.

Presently, various techniques exist for meeting these requirements to varying degrees, but none are fully satisfactory in all respects. Thus, for example, an auxiliary power supply can be simply created by providing a resistor or linear regulator operating off the main voltage supply. Such a solution is inexpensive, but not efficient, particularly when the main voltage is high. Alternatively, an auxiliary supply can be created by providing an extra winding on an existing switched inductor or transformer, which is an efficient but costly solution. Additionally, output relation of the auxiliary supply will be less than optimum, since voltage regulation will be affected by operating point changes in the main power converter operating off the same transformer or inductor. Finally, an auxiliary supply can be created by using a small self-oscillating converter, formed of either discrete transistors and a transformer or a partiallyintegrated control and switching circuit. Although such solutions are efficient and do not suffer from regulation problems, they can be costly.

Several different power supply configurations, using various prior-art techniques for generating an auxiliary power supply and employing partial integration, are disclosed in A TRIPLE LOW-SIDE DRIVER POWER IC WITH REGULATION AND MICROPROCESSOR INTERFACE CONTROL, Thiel and Hach, IEEPESC, pp. 806-811, 1991; FUTURE DEVELOPMENT IN ELECTRONIC SYSTEMS IS IMPACTED BOTH BY SEMICONDUCTOR TECHNOLOGY AND IC ASSEMBLY TECHNIQUES, Murari, ESSDERC '96, pp. 4044, 1996; and U.S. Pat. No. 5,739,582. Additionally, a switching power converter employing a partially-integrated self-oscillating converter using a relatively expensive flyback transformer is used in the Philips “Greeny” chip (part number TEA1501). All of the foregoing prior-art configurations suffer to some degree from the disadvantages of complexity, inefficiency, high cost, large size and/or the inability to achieve maximum possible integration.

Accordingly, it would be desirable to have an integrated switching power converter which is relatively simple, efficient, economical, compact, and easily integrated.

### SUMMARY OF THE INVENTION

It is therefore an object of the invention to provide an integrated circuit switching power converter which is simple and compact in construction, efficient to operate, economical to produce, and easily integrated into a single IC package, with a minimum of external components. In accordance with the invention, these objects are achieved by a new IC switching power converter of the type having a main power supply and an auxiliary power supply, in which all of the integrated components of the main power supply and the auxiliary power supply are formed in a single IC die which is mounted in a single IC package.

In a preferred embodiment of the invention, the main power supply and the auxiliary power supply share at least one external electrical connection pin of the single IC package.

In a further preferred embodiment of the invention at least one circuit is shared in common by the main power supply and the auxiliary power supply, thus making the power converter circuit simpler, more compact and more economical to manufacture.

These and other objects of the invention will be apparent from and elucidated with reference to the embodiments described hereinafter.

### BRIEF DESCRIPTION OF THE DRAWING

The invention may be more completely understood with reference to the following description, to be read in conjunction with the accompanying drawing, in which:

FIG. 1 shows a simplified block diagram of an integrated circuit switching power converter in accordance with a first embodiment of the invention;

FIG. 2 shows a simplified block diagram of an integrated circuit switching power converter in accordance with a second preferred embodiment of the invention; and

FIG. 3 shows a simplified block diagram of an integrated circuit switching power converter in accordance with a third preferred embodiment of the invention.

### DESCRIPTION OF THE PREFERRED EMBODIMENTS

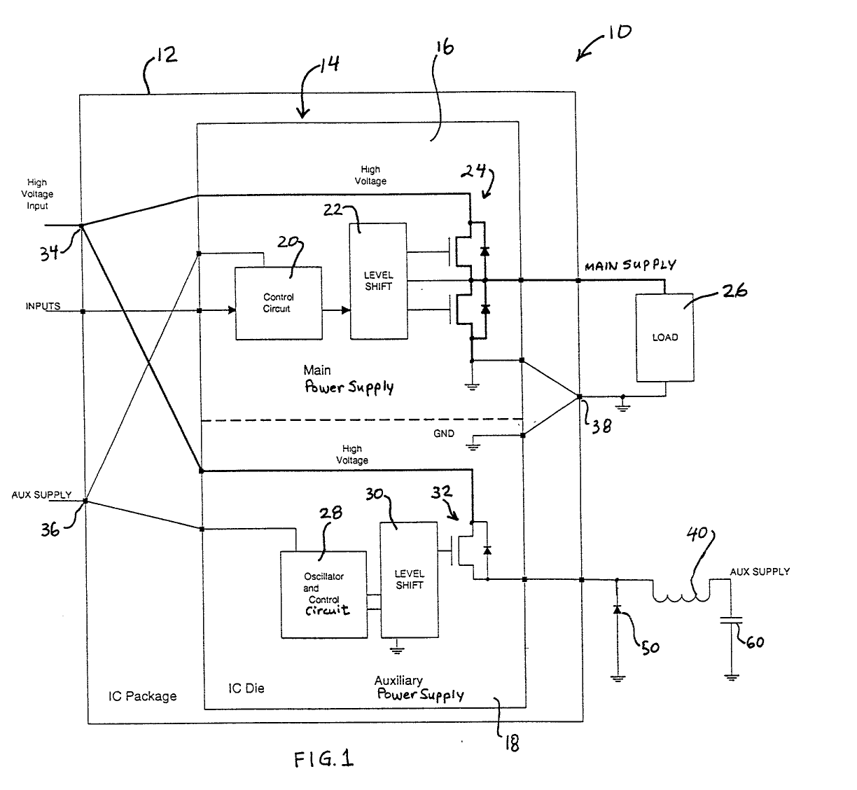

A simplified diagram of an integrated circuit switching power converter is shown in FIG. 1. In the block diagram of FIG. 1, an integrated circuit switching power converter 10 includes a single IC package 12 containing a single IC die 14 which has both a main power supply section 16 and an auxiliary power supply section 18 which are separated for purposes of illustration by a dashed line.

Although various different configurations for the main power supply and auxiliary power supply are contemplated within the scope of the invention, for purposes of illustration the main power supply 16 as shown in FIG. 1 is composed of a control circuit 20 coupled to a level shift circuit 22 which in turn feeds an output circuit 24 which drives an external load 26. While various different types of output circuits can be employed, a half-bridge output circuit 24 is shown for illustration.

The auxiliary power supply 18, also on IC die 14, illustratively includes an oscillator and control circuit 28 feeding a level shift circuit 30, which in turn drives output circuit 32. Again, it should be emphasized that many different configurations are possible for the individual circuits of the auxiliary power supply as well as the main power supply, and accordingly such circuits are not shown in further detail herein.

In the block diagram of FIG. 1, package or die pins are shown by small solid squares. In accordance with the invention, at least one external electrical connection pin of the single IC package 12 is shared by the main power supply 16 and the auxiliary power supply 18, both of which are formed on the single IC die 14. In FIG. 1, the shared connection pins are the high (main) voltage input pin 34, AUX (auxiliary) SUPPLY pin 36, and ground (GND) pin 38. Additionally, it is noted that the output circuit 32 of the auxiliary power supply 18 is connected in a down (or “buck”) converter configuration with diode 50, capacitor 60 and inductor 40. The output of this down converter, designated AUX SUPPLY, can be used as the low-voltage supply for control circuit 20 of the main power supply and the oscillator and control circuits 28 of the auxiliary power supply (pin 36), and other circuits requiring a low voltage supply.

By incorporating all of the integrated components of the main power supply and the auxiliary power supply into a single IC die which is mounted in a single IC package, and then providing one or more common external electrical connection pins for both internal power supply circuits, a simple, compact and economical construction is achieved.

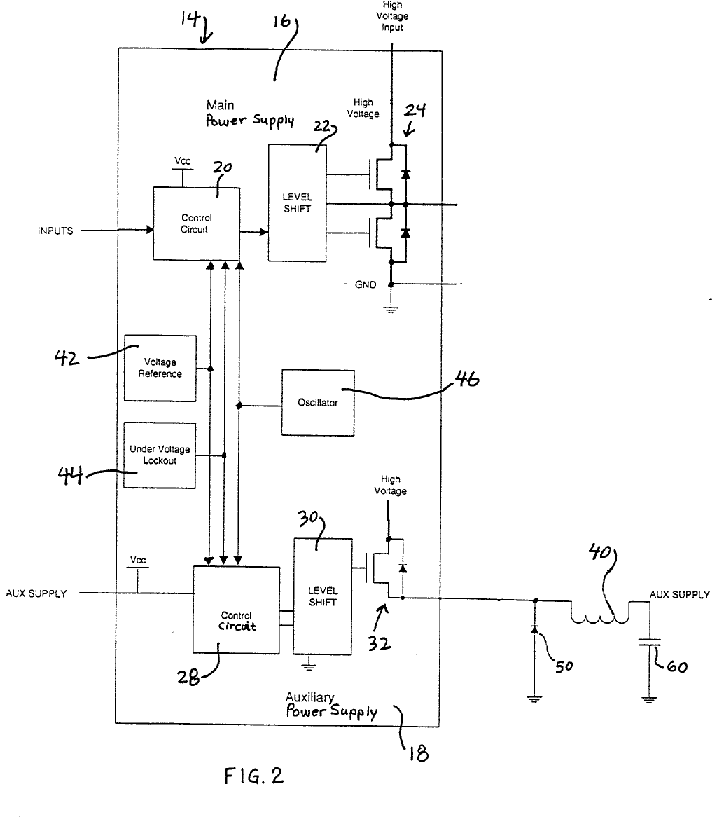

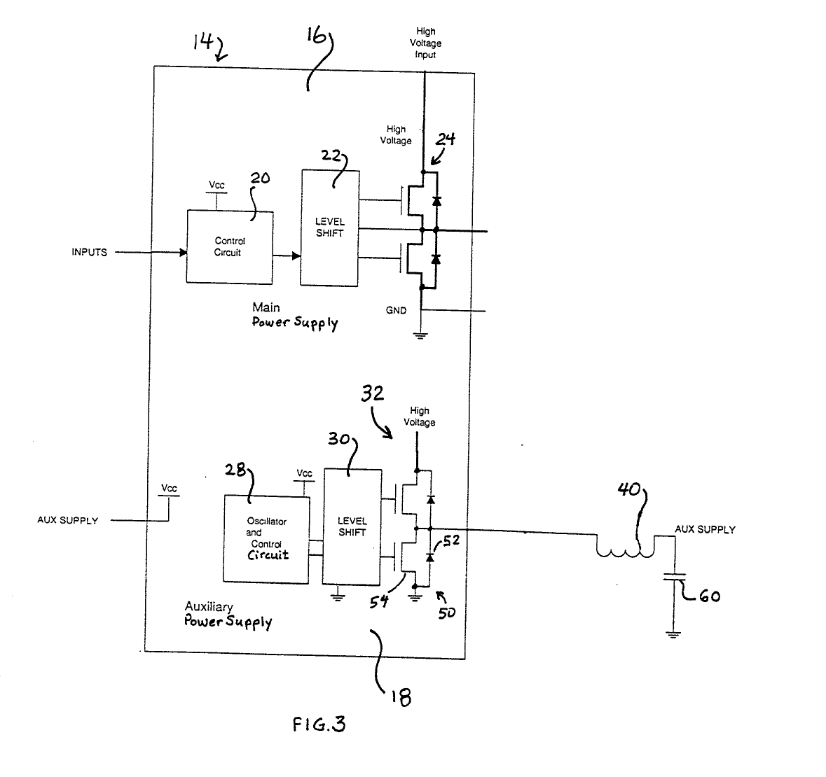

Further preferred embodiments of the invention are shown in FIGS. 2 and 3, in which components already described in connection with FIG. 1 are provided with like reference numerals and are not further described in the interest of brevity.

The main feature shown in the simplified block diagram of FIG. 2 is the sharing of circuitry between the main power supply 16 and the auxiliary power supply 18, both of which are formed on the same IC die 14. Since both power supplies are mounted on the same IC die, certain circuits, such as voltage reference circuit 42, under voltage lockout circuit 44 and oscillator circuit 46, can be provided once on the IC die 14 and used to provide signals to both the main and auxiliary power supplies, thus further reducing cost, size and complexity. For example, whereas block 28 of the auxiliary power supply in FIG. 1 requires its own oscillator, in FIG. 2 block 28 need only be a control circuit, with the oscillator (46) being shared in common with the block 20 of the main power supply. It will be recognized that the particular circuits being shown as shared in FIG. 2 are illustrative in nature, and that various other circuits may be shared by the two power supplies as appropriate for the particular power supply configuration being employed in a given application. It should also be noted that such circuit sharing can not only decrease size, cost and power consumption, but can also improve performance. For example, the use of a common oscillator 46 for the two power supplies, rather than two separate oscillators can improve the electrical noise performance of the entire system.

A further reduction in cost may be achieved by using the configuration shown in the simplified block diagram of FIG. 3. In the embodiment shown in FIGS. 1 and 2, the auxiliary power supply 18 is provided with a “freewheeling” diode 50 to provide a current path when the output circuit 32 is switched off. In FIGS. 1 and 2, as in the prior art, this diode is provided as a discrete component, external to the IC die. However, a further saving in cost can be achieved by integrating this diode (or an active equivalent) into the IC die 14, as shown in FIG. 3. Furthermore, as also shown in FIG. 3, the diode 50 function may be performed by a synchronous rectifier, shown schematically as a diode 52 connected in parallel with a transistor switch 54 that is turned on during the diode conduction time. Such a configuration will improve the efficiency of the auxiliary power supply while providing a compact and cost-effective configuration. It should be noted that in the actual physical implementation of the synchronous rectifier, the diode 52 would be a part of the structure of MOS transistor 54 and not a separate element. Finally, it should be noted that integrated circuit switching power converters in accordance with the invention may be fabricated by any one of a number of semiconductor fabrication technologies well known to those of ordinary skill in the art. A particularly advantageous process technology for fabrication of the present invention employs the use of a high-voltage silicon-on-insulator semiconductor fabrication process, such as the Philips Semiconductors'EZ-HVTM process, which supports high-voltage transistors that can float to high voltages above ground potential. In such a technology, the various control circuits for the main and auxiliary power supplies can be referenced to ground potential, while other circuits, such as the output circuit of the auxiliary converter, can be at a high potential.

In this manner, the present invention provides an integrated circuit switching power converter which is simply and compact in construction, efficient to operate, economical to produce, and easily integrated into a single IC package, with a minimum of external components.

While the invention has been particularly shown and described with reference to several preferred embodiments thereof, it will be understood by those skilled in the art that various changes in form and detail may be made without departing from the spirit or scope of the invention. In this application it should be understood that the word “a” or “an” preceding an element does not exclude the presence of a plurality of such elements, and that the word “comprising” does not exclude the presence of other elements or steps than those described or claimed.

What is claimed is:

1. An integrated circuit (IC) switching power converter having a main power supply for providing a main voltage output and an auxiliary power supply for providing an auxiliary voltage output lower than said main voltage output, characterized in that all integrated components of said main power supply and said auxiliary power supply are formed in a single IC die which is mounted in a single IC package.

2. An integrated circuit (IC) switching power converter as in claim 1, where in said main power supply and said auxiliary power supply share at least one external electrical connection pin of said single IC package.

3. An integrated circuit (IC) switching power converter as in claim 2, wherein said at least one external electrical connection pin comprises a ground pin.

4. An integrated circuit (IC) switching power converter as in claim 2, wherein said at least one external electrical connection pin comprises a main voltage input pin.

5. An integrated circuit (IC) switching power converter as in claim 2, wherein said at least one external electrical connection pin comprises an auxiliary voltage output pin.

6. An integrated circuit (IC) switching power converter as in claim 1, wherein said main power supply and said auxiliary power supply share at least one circuit.

7. An integrated circuit (IC) switching power converter as in claim 6, wherein said at least one circuit comprises a voltage reference circuit.

8. An integrated circuit (IC) switching power converter as in claim 6, wherein said at least one circuit comprises a control circuit.

9. An integrated circuit (IC) switching power converter as in claim 6, wherein said at least one circuit comprises an oscillator circuit.

10. An integrated circuit (IC) switching power converter as in claim 1, wherein the integrated components of said auxiliary supply comprise at least one output diode element.

11. An integrated circuit (IC) switching power converter as in claim 10, wherein said at least one output diode element comprises a synchronous rectifier.
